(19) United States
(12) Patent Application Publication
(10) Pub. No.: US 2007/0147294 A1
(43) Pub. Date: Jun. 28, 2007

(54) COMMUNICATIONS SYSTEM

(75) Inventors: Vanu Bose, Cambridge, MA (US); John M. Chapin, Arlington, MA (US); Steve Muir, Philadelphia, PA (US); Jeffrey Steinheider, Arlington, MA (US); Victor Lum, Cambridge, MA (US)

Correspondence Address: FISH & RICHARDSON PC, P.O. BOX 1022, MINNEAPOLIS, MN, 55440-1022, US

(73) Assignee: Vanu, Inc., a Delaware corporation

(21) Appl. No.: 11/682,110

(22) Filed: Mar. 5, 2007

Related U.S. Application Data
(63) Continuation of application No. 10/716,180, filed on Nov. 17, 2003.
(60) Provisional application No. 60/426,862, filed on Nov. 15, 2002.

(51) Int. Cl. H04Q 7/00; H04L 12/28

(52) U.S. Cl. 370/329; 370/431

(57) ABSTRACT

In one aspect, the invention is a method for allocating channels. The method includes determining a communication standard used by a message and determining available channels. The method also includes allocating a channel based on the available channels and the communication standard used by the message. The method may also include sending an instruction to use the channel.

### PRIORITY TO OTHER APPLICATIONS

This application claims priority from and incorporates herein U.S. Provisional Application No. 60/426,862, filed Nov. 15, 2002, and titled “Transporting Digital Data”.

### BACKGROUND OF THE INVENTION

Wireless communication includes a number of standards, for example, the Advance Mobile Phone Service (AMPS), Global System for Mobile communications (GSM), Time Division Multiple Access (TDMA) standards and the like. Typically, when communication standards are changed or become obsolete within a particular communications system, hardware associated with the obsolete standard is replaced. For example, a channel card is replaced.

To ensure reliability, communications systems require redundancy in their architecture to ensure that no data is lost if any hardware unit fails. Typically, redundancy is accomplished by having redundant components for each key component.

It is an important object of the invention to provide an improved wireless software-defined signal processing system that has the flexibility to fully utilize channels based on the communication standard required. It is another object of the invention to provide a communications system that includes redundancy based on the protocol requirements while minimizing the amount of hardware used.

### BRIEF SUMMARY OF THE INVENTION

Traditional wireless communication systems, such as a basestation architecture, use channel cards, which provide the transmission and reception capability for a given number of channels for a particular wireless standard. In order to change standards, wireless providers must physically replace the channel cards. For example, this may entail driving many miles to a radio tower that includes the channel cards. As service providers transition between communication standards, it is necessary over time to replace channel cards using the old standard with channel cards using the new standard as more customers start using phones or other wireless devices that support the new standard. This is not only costly, requiring a person to drive-out to each to a radio tower every time the provider wants to re-apportion some of the spectrum in a given location, but it also results in inefficient spectrum utilization. For example, providers are still required to support AMPS today, and apportion part of their spectrum for AMPS even though there is very little traffic on the AMPS channels.

In one aspect, the invention is a method for allocating channels. The method includes determining a communication standard used by a message and determining available channels. The method also includes allocating a channel based on the available channels and the communication standard used by the message.

In another aspect the invention is an apparatus for allocating channels. The apparatus includes a memory that stores executable instruction signals and a processor. The processor executes the instruction signals to determine a communication standard used by a message, to determine available channels and to allocate a channel based on the available channels and the communication standard used by the message.

In a still other aspect, the invention is an article that includes a machine-readable medium that stores executable instruction signals for allocating channels. The instruction signals cause a machine to determine a communication standard used by a message, to determine available channels, and to allocate a channel based on the available channels and the communication standard used by the message.

In another aspect the invention is a software-defined signal processing system. The system includes a controller and a set of primary servers. Each primary server includes software required to execute a communications standard. The system also includes a back-up server that supports the set of primary servers in case of failure. The back-up server is configured to perform the functions of a failed server from the set of primary servers when the failed server fails.

The aspects above may have one or more of the following features. The invention allows for the channels within a communications system to be dynamically chosen based on communications standard required by a message rather than statically choosing the channel to uses a communications standard of only one standard thereby eliminating the requirement of someone physically traveling to remote locations within a communications network to replace hardware. The communication standard used by a channel is determined dynamically as current usage patterns dictate rather than having the communication standard on a quasi-static channel preassigned as occurs through the use of traditional line cards.

The communications system also includes a set of generic servers that are backed-up by at least one generic server thereby saving cost in having a large number of servers that are specific to a particular communications standard.

### BRIEF DESCRIPTION OF THE SEVERAL VIEWS OF THE DRAWING

FIG. 1 is a block diagram of a wireless communication system;

FIG. 2 is a block diagram of a software-defined signal processing system.

FIG. 3 is flowchart for allocating a channel; and

FIG. 4 is a block diagram of a computer system on which the process of FIG. 3 may be implemented.

### DETAILED DESCRIPTION OF THE INVENTION

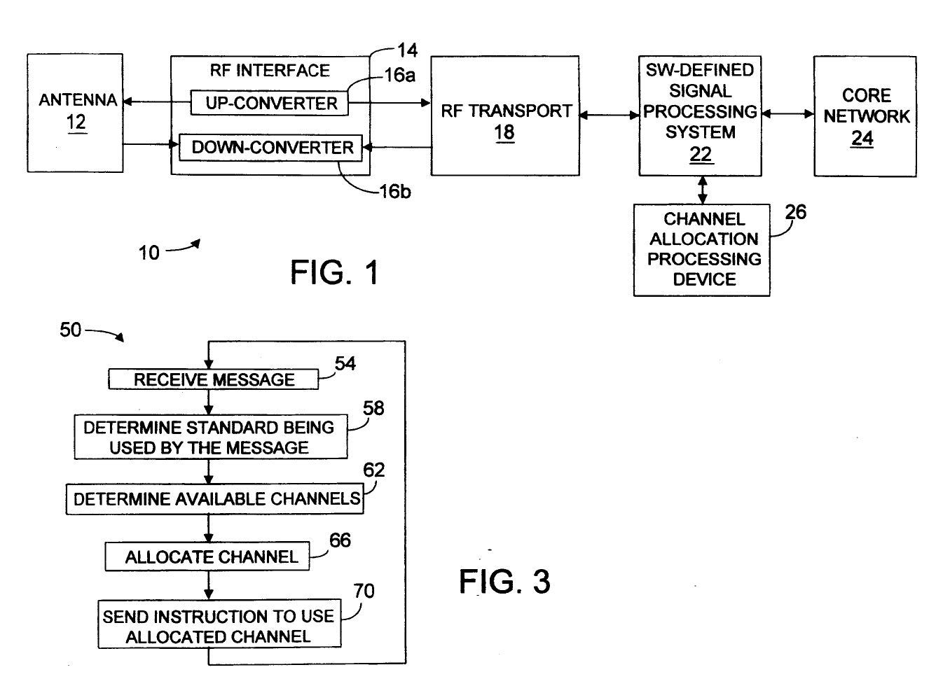

Referring to FIG. 1, a wireless communications system 10 includes an antenna 12, a radio frequency (RF) interface 14, a digital RF transport mechanism 18, a software (SW) signal processing system 22, a core network 24 (e.g., a wireless service provider) and a channel-allocation processor device 26. The RF interface 14 receives and transmits RF signals through antenna 12 using a up-converter 16a and an down-converter 16b. For example, when a signal is received, the down-converter 16b converts the signal from an RF signal to an intermediate frequency (IF) or baseband signal and digitizes the resultant signal. When a signal is transmitted, the up-converter 16a converts the signal from a baseband or IF signal to an RF signal and amplifies the RF signal for transmission. The up-converter 16a and down-converter 16b use a block of spectrum that contains more than one channel.

The digital RF transport mechanism 18 transports digital samples between the RF interface 14 and the software-defined signal processing system 22. In one embodiment, the RF transport mechanism 18 may be include fiber lines extending over many miles with a network interface that are connected to the software-defined signal processing system. In another embodiment, transport mechanism 18 includes a peripheral component interconnect (PCI) card having an analog-to-digital (A/D) converter and a digital-to-analog converter (D/A) on the PCI card, which transports the data into a software-defined signal processing system via the PCI bus.

The software-defined signal processing system 22 processes the digitized signals in accordance with the specification for one or more communication standards for signals received from internal network 24 or signals processed for the internal network. The particular processing being performed by the system 22 is to define generic servers by loading onto generic servers software specific to a communication standard required by the communications system 10. Thus, system 22 can be used with multiple communication standards using the same hardware. An example of the software-defined signal processing system and wireless communication system are found in U.S. Pat. No. 6,584,146 entitled “SYSTEMS AND METHODS FOR WIRELESS COMMUNICATION”, by Vanu Bose et al., which is incorporated in its entirety herein.

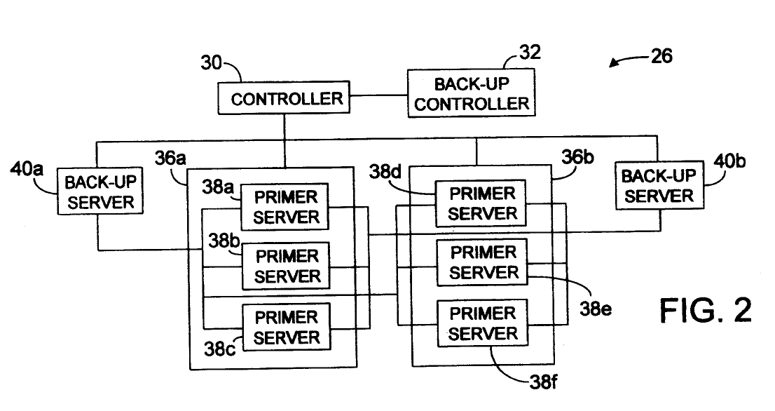

Referring to FIG. 2, software-defined signal processing system 22 includes a controller 30 and clusters (e.g., cluster 36a and cluster 36b). Each cluster contains primary servers (e.g., primary server 38a, primary server 38b, primary server 38c, primary server 38d, primary server 38e and primary server 38f). Each primary server 38a-38f is loaded with the applicable software (i.e, software compliant with the appropriate communications standard) by the controller 30 from a central server (not shown). The applicable software includes files, libraries and the like required to execute a particular communications standard. Therefore, each primary server 38-38f is generic and independent with respect to any particular communications standard.

Software-defined signal processing system 22 also includes a back-up controller 32 and back-up servers (e.g. back-up server 40a and back-up server 40b). Backup-controller 32 is fully redundant to controller 30. For example, if controller 30 fails, back-up controller 30 performs the functions of the controller. Backup-server 40a provides redundancy to primary servers 38a-38f and back-up server 40b provides redundancy to primary servers 38a-38f. Back-up server 40a and back-up server 40b are assigned to primary servers 38a-38c and primary servers 38d-38f respectively by controller 30a. The redundancy plan of which back-up server supports which primary servers is periodically updated as load shifts over the course of time. Each backup server 40a and 40b preallocates all software objects, network connections, and memory buffers needed to mirror the processing of the primary server, but does not initiate any processing. This enables a single server to act as backup for a number of primary servers without CPU load limitation, and to quickly begin processing if any of the primaries fail. After a primary server fails and its backup server is activated, the controller 30 reallocates each of the primary servers previously assigned to that backup server to a different backup server.

The channel-allocation process device 26 includes a database 82 that contains a list of the available channels. The channel-allocation process device 26 determines the channel to use based on the channels that are available in the database 82 and the communication standard required to be supported and directs the signal processing system 22 to assign the signal to that channel.

Referring to FIG. 3, a process 50 is an exemplary process for allocating channels based on a communication standard used by the message and the channels available. Process 50 receives (54) a message (e.g., a call, traffic, short-messaging or text, a broadcast, housekeeping signal, intended consumer signals and the like). The message may be a received message (i.e., a message received from RF interface 14) or a message to be transmitted (i.e., a message that will be sent to RF interface 14 for transmission). Each message is in a format compliant with a communications standard. For example, AMPS, GSM or the like. Process 50 determines (58) the communications standard used by the message. Process 50 determines (62) the available channels. For example, channel-allocation device 26 reads database 82 which contains a list of available channels. Process 50 allocates (66) a channel. For example, channel-allocation device 26 determines the bandwidth required from the bandwidth requirements of the communications standard, e.g., AMPS requires 30 kHz bandwidth and GSM requires a 200 kHz bandwidth. Channel-allocation device 26 determines the frequencies licensed to the user of the message. Channel-allocation device 26 chooses from the list of available channels a channel that meets the frequency and bandwidth requirements. Process 50 sends (70) an instruction to use the allocated channel. For example, channel-allocation processing device 26 sends an instruction to the SW-defined signal processing device 22 which in turn sends a message to a mobile device to use the allocated channel. Process 50 continues allocating channels as messages are received. Using process 50 and dynamically responding to the offered load of messages, the spectrum is utilized in the most efficient manner given the current usage pattern.

For example, a common transition that some providers are currently undergoing is upgrading 800 MHz analog cellular systems to 800 MHz GSM systems. While the GSM traffic is quickly overtaking the analog traffic, providers are required by applicable law to support AMPS for several more years, and also have a few customers with unique needs that are best served by the analog system. Typically, a small number of frequencies are reserved for AMPS, and the rest are transitioned over to GSM by adding GSM channel cards as the GSM traffic grows. The AMPS channels are dormant most of the time, except for occasional roaming traffic or occasional use by the few subscribers that still use analog phones.

Using process 50, AMPS could continue to be supported without having to waste parts of the spectrum by statically assigning voice channels to the AMPS system.

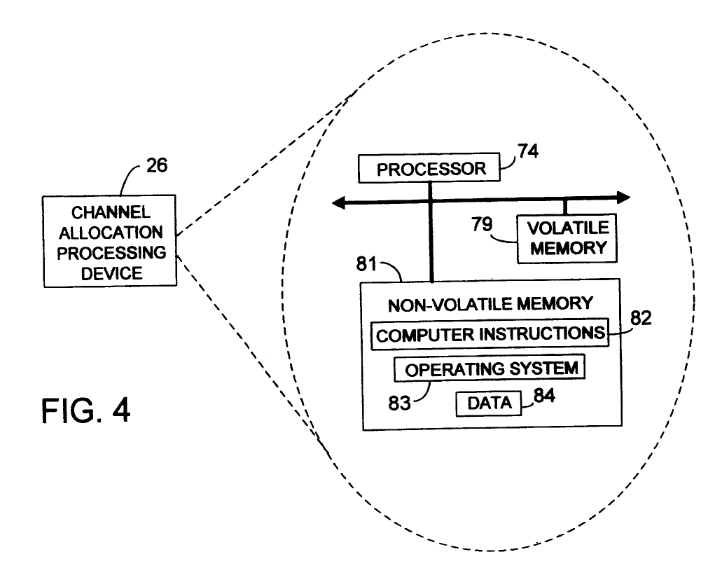

FIG. 4 shows one example of the channel-allocation processing device 26. Device 26 includes a processor 74 for allocating channels, a volatile memory 79, and a non-volatile memory 81 (e.g., hard disk). Non-volatile memory 81 stores operating system 83, data 84 that includes data related to wireless communication standards, allocated channels and unallocated channels. Non-volatile memory also includes computer instructions 82 which are executed by processor 74 out of volatile memory 79 to perform process 50. In one embodiment, computer instructions include executable instruction signals.

Process 50 is not limited to use with the hardware and software of FIG. 4; process 50 may find applicability in any computing or processing environment and with any type of machine that is capable of running a computer program. Process 50 may be implemented in hardware, software, or a combination of the two. Process 50 may be implemented in computer programs executed on programmable computers/machines that each include a processor, a storage medium/article of manufacture readable by the processor (including volatile and non-volatile memory and/or storage elements), at least one input device, and one or more output devices. Program code may be applied to data entered using an input device to perform process 50 and to generate output information.

Each such program may be implemented in a high level procedural or objected-oriented programming language to communicate with a computer system. However, the programs can be implemented in assembly or machine language. The language may be a compiled or an interpreted language. Each computer program may be stored on a storage medium (article) or device (e.g., CD-ROM, hard disk, or magnetic diskette) that is readable by a general or special purpose programmable computer for configuring and operating the computer when the storage medium or device is read by the computer to perform process 50. Process 50 may also be implemented as a machine-readable storage medium, configured with a computer program, where upon execution, instructions in the computer program cause the computer to operate in accordance with process 50.

The invention is not limited to the specific embodiments described herein. The invention is not limited to the specific processing order of FIG. 3. Rather, the blocks of FIG. 3 may be re-ordered, as necessary, to achieve the results set forth above. The channel-allocation processing device is not limited to interfacing with one software defined signal processing system. Rather, the channel-allocation processing device can perform channel allocation with multiple software defined signal processing systems, interfaced with one central database that handles channel assignment across all of the software defined processing systems. New communications standards can be added as software upgrades and incorporated into the channel-allocation processing device.

In still other embodiments, the software-defined signal processing system 22 includes the channel-allocation processing device 26.

In still other embodiments, a back-up controller is not used and instead controller 30 includes redundancy features within the controller such as a mirrored set of servers and the like.

Other embodiments not described here are also within the scope of the following claims. For example, there has been described novel apparatus and techniques for decoding convolutional codes. It is evident that those skilled in the art may now make numerous modifications and uses of and departures from specific apparatus and techniques herein disclosed without departing from the inventive concepts. Consequently, the invention is to be construed as embracing each and every novel feature and novel combination of features present in or possessed by the apparatus and techniques herein disclosed and limited solely by the spirit and scope of the appended claims.

What is claimed is:

1-23. (canceled)

24. A radio communication system base station comprising:
a radio transceiver comprising:
a wideband radio transmitter configured to transmit a first set of signals comprising one or more information signals on one or more frequencies to one or more mobile devices, the wideband radio transmitter comprising:
an analog to digital converter configured to convert received signals into digital samples; and
a digital to analog converter configured to convert digital samples into analog signals; and
a down-converter configured to convert received radio frequency signals to baseband signals for digitization; and
an up-converter configured to convert baseband signals from the digital to analog converter to radio frequency signals for transmission; and
a wideband radio receiver configured to receive a second set of signals comprising one or more information signals on the one or more frequencies from the one or more mobile devices;
a signal processing subsystem disposed remotely from the radio transceiver, the signal processing subsystem being configured to:
demodulate information from digital samples of signals received from the radio transceiver; and
modulate information into digital samples of signals to be transmitted by the radio transceiver; and
a data transport mechanism communicatively coupled to the radio transceiver and the signal processing subsystem, the data transport mechanism being configured to:
transport digital information signals and control information from the radio transceiver to the signal processing subsystem; and
transport digital information signals and control information from the signal processing subsystem to the radio transceiver.

25. The radio communication system base station of claim 24, wherein the signals included in the first and second sets of information signals comprise signals having the same communication protocol.

26. The radio communication system base station of claim 24, wherein the signals included in the first and second sets of information signals comprise signals having different communication protocols.

27. The radio communication system base station of claim 24, wherein the signals included in the first and second sets of information signals comprise signals having the same symbol and chip rates.

28. The radio communication system base station of claim 24, wherein the signals included in the first and second sets of information signals comprise signals having different symbol and chip rates.

29. The radio communication system base station of claim 24, wherein the radio transceiver is further configured to:
convert the received radio frequency signals to an intermediate frequency; and
subsequent to converting the signal to an intermediate frequency, convert the signals to baseband signals.

30. The radio communication system base station of claim 24, wherein the radio transceiver is further configured to:
convert the baseband signals from the digital to analog converter to an intermediate frequency; and
subsequent to converting the signal to an intermediate frequency converting the signals to radio frequency signals.

31. The radio communication system base station of claim 24, wherein the transceiver is configured to sum in the digital domain multiple signals to be transmitted.

32. The radio communication system base station of claim 24, wherein the signal processing subsystem is further configured to perform equalization.

33. The radio communication system base station of claim 24, wherein the signal processing subsystem is further configured to perform power control.

34. The radio communication system base station of claim 24, wherein the signal processing subsystem is further configured to perform forward error correction on the received signal.

35. The radio communication system base station of claim 24, wherein the signal processing subsystem is further configured to:
perform coding of the transmitted signal; and
perform decoding of the received signal.

36. The radio communication system base station of claim 24, wherein the signal processing subsystem is further configured to perform despreading of the received signal.

37. The radio communication system base station of claim 24, wherein the signal processing subsystem is further configured to:
perform interleaving of the transmitted signal; and
perform de-interleaving of the received signal.

38. The radio communication system base station of claim 24, wherein the signal processing subsystem is further configured to control a time at which the digital samples are transmitted by the signal transceiver based on a time of receipt of a corresponding signal by the transceiver.

39. The radio communication system base station of claim 24, wherein the signal processing subsystem is co-located with at least one of a base station controller and a mobile switching center.

40. The radio communication system base station of claim 24, wherein the signal processing subsystem is disposed remotely from at least one of a base station controller and a mobile switching center.

41. The radio communication system base station of claim 24, wherein the signal processing subsystem is configured to perform all signal processing using software.

42. The radio communication system base station of claim 41, wherein the signal processing subsystem is configured to execute on a linux operating system.

43. The radio communication system base station of claim 24, wherein the data transport mechanism comprises a packetized data transport mechanism.

44. The radio communication system base station of claim 24, wherein the data transport mechanism comprises a packetized data transport over circuit switched transport.

45. The radio communication system base station of claim 24, wherein the data transport mechanism comprises a serial data transport mechanism.

46. The radio communication system base station of claim 24, wherein the data transport mechanism is configured to transmit one or more of optical, electrical, or radio-based communications.

47. The radio communication system base station of claim 24, wherein the data transport mechanism comprises an Ethernet connection.

48. The system of claim 24, wherein the digital signal includes multiple channels and the signal processing subsystem is further configured to sum the channels in a digital domain.

49. The system of claim 24, wherein the radio communication system base station is further configured to:
receive from the base station a digital signal that includes multiple channels;
separate the multiple channels of the digital signal to form separated digital channels; and
perform a digital to analog conversion on the separated digital channels.

50. The system of claim 24, wherein the base station comprises a software-based signal processing system.

51. The system of claim 50, wherein the software-based signal processing system is configured to process digital signals received from the radio transciever.

52. A method comprising:
distributing processing of a signal received from a wireless device between a base station and a base station controller by performing a first portion of the signal processing at the base station and performing a second portion of the signal processing at the base station controller, wherein performing the first portion of the signal processing comprises:
performing an analog to digital conversion of a received signal; and
filtering the converted received signal.

53. The method of claim 52, wherein filtering the received signal comprises digitally filtering the received signal.

54. The method of claim 52, wherein filtering the received signal comprises summing multiple channels of the received signal in a digital domain.

55. The method of claim 52, wherein performing the second portion of the signal processing at the base station controller comprises performing power control.

56. The method of claim 52, wherein performing the second portion of the signal processing at the base station controller comprises performing channel allocation.

57. A method comprising:
receiving a signal from a wireless device at a base station;
performing analog to digital conversion on the received signal at the base station to generate a digital signal;
performing digital filtering of the digital signal at the base station to generate a partially-processed signal;
sending the partially-processed signal from the base station to a base station controller; and
performing additional signal processing on the partially-processed signal at the base station controller.

58. The method of claim 57, wherein sending the processed signal from the base station to the base station controller comprises sending the processed signal from the base station to the base station controller via a transport medium between the base station and the base station controller.

59. A method comprising:
digitally filtering a signal received at a base station from a wireless device to generate a partially-processed signal;
sending the partially-processed signal from the base station to a base station controller.
